(19) United States
(12) Patent Application Publication
(10) Pub. No.: US 2021/0012064 A1
(43) Pub. Date: Jan. 14, 2021

(54) RECORDING MEDIUM RECORDING COMPLEMENTARY PROGRAM, COMPLEMENTARY METHOD, AND INFORMATION PROCESSING DEVICE

(71) Applicant: FUJITSU LIMITED, Kawasaki-shi (JP)

(72) Inventors: Sayuri Nakayama, Kawasaki (JP); Kiyonori Morioka, Kawasaki (JP); TARO TOGAWA, Kawasaki (JP)

(73) Assignee: FUJITSU LIMITED, Kawasaki-shi (JP)

(21) Appl. No.: 16/915,208

(22) Filed: Jun. 29, 2020

(30) Foreign Application Priority Data
Jul. 11, 2019 (JP) 2019-129624

(51) Int. Cl. G06F 40/20; G10L 15/26; G06K 9/00; G06F 40/30; G10L 17/26

(52) U.S. Cl. CPC G06F 40/20; G10L 15/26; G06K 9/00302; G06F 40/30; G10L 17/26; G06K 9/00335

(57) ABSTRACT

A recording medium stores a program causing a computer to execute processing including: specifying demonstrative words from character information; extracting a first feature of a first referent corresponding to a first demonstrative word, and a second feature of a second referent corresponding to a second demonstrative word; calculating a similarity between the first feature and the second feature corresponding to a same one of the genres; calculating a degree of attention based on information out of the voice information, the character information, and the image information; selecting at least genres based on the similarity and the degree of attention; creating a first complementary word obtained by modifying a name of the first referent with the first feature corresponding to each of the selected genres; and creating a second complementary word obtained by modifying a name of the second referent with the second feature corresponding to each of the selected genres.

### CROSS-REFERENCE TO RELATED APPLICATION

This application is based upon and claims the benefit of priority of the prior Japanese Patent Application No. 2019-129624, filed on Jul. 11, 2019, the entire contents of which are incorporated herein by reference.

### FIELD

The embodiments discussed herein are related to a complementary program and the like.

### BACKGROUND

There is a conversation recording technique of recording a voice of a conversation and transforming the recorded voice into text. This conversation recording is used in a variety of situations, such as a customer service conversation between a clerk and a customer, statements at a conference, and guidance at a private-tutoring school.

Japanese Laid-open Patent Publication No. 2007-272534, Japanese Laid-open Patent Publication No. 2011-086123, Japanese Laid-open Patent Publication No. 10-040068, and Japanese Laid-open Patent Publication No. 2000-242640 are disclosed as related art.

### SUMMARY

According to an aspect of the embodiments, a non-transitory computer-readable recording medium stores therein a complementary program for causing a computer to execute processing including: specifying a plurality of demonstrative words from character information extracted from voice information; extracting, from among the plurality of demonstrative words, a first feature of a first referent corresponding to a first demonstrative word for each of genres, and a second feature of a second referent corresponding to a second demonstrative word for each of the genres, one by one on a basis of image information; calculating a similarity between the first feature and the second feature corresponding to a same one of the genres for each of the genres; calculating a degree of attention for each of the genres on a basis of at least one or more pieces of information out of the voice information, the character information, and the image information; selecting at least one or more genres on a basis of the similarity and the degree of attention; creating a first complementary word obtained by modifying a name of the first referent with the first feature corresponding to each of the selected one or more genres; and creating a second complementary word obtained by modifying a name of the second referent with the second feature corresponding to each of the selected one or more genres.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a system according to a first embodiment;

FIG. 2 is a diagram illustrating an exemplary microphone terminal;

FIG. 3 is a functional block diagram illustrating a configuration of a relay device;

FIG. 4 is a diagram for explaining processing of a complementary device according to the first embodiment;

FIG. 5 is a functional block diagram illustrating a configuration of the complementary device according to the first embodiment;

FIG. 6 is a diagram illustrating an exemplary data structure of a feature table;

FIG. 7 is a diagram (1) for explaining processing of feature extraction unit;

FIG. 8 is a diagram (2) for explaining processing of the feature extraction unit;

FIG. 9 is a diagram for explaining another type of processing of the feature extraction unit;

FIG. 10 is a diagram illustrating an exemplary data structure of a word dictionary;

FIG. 11 is a flowchart illustrating a processing procedure of the complementary device according to the first embodiment;

FIG. 12 is a diagram illustrating a system according to a second embodiment;

FIG. 13 is a functional block diagram illustrating a configuration of a complementary device according to the second embodiment;

FIG. 14 is a diagram illustrating an exemplary processing procedure of the complementary device according to the second embodiment;

FIG. 15 is a diagram illustrating an exemplary hardware configuration of a computer that implements functions similar to those of the complementary device; and

FIG. 16 is a diagram for explaining voice recognition.

### DESCRIPTION OF EMBODIMENTS

Here, if the voice of the conversation is directly transformed into text by the conversation recording technique, there is a case where the sentence becomes incomprehensible; therefore, there is a technique of complementing the text. For example, when the voice of a conversation between two or more users is transformed into text, omitted subjects, objects, and the like are complemented based on users' position information and action information, and object information around the users.

However, in the above-mentioned related art, there is a problem that, when two or more similar referents are stated by a demonstrative word, it is difficult to create appropriate complementary words from the stated demonstrative word.

In a conversation between humans, a demonstrative word such as “that, it, this” is often used based on the common recognition on-site. With regard to the voice of a spoken demonstrative word, if the voice is simply transformed into text by the conversation recording technique, a user who refers to the text fails to understand the meaning of the demonstrative word in some cases.

Note that it is conceivable to specify a referent using image information captured by a camera to perform object recognition, and correct a demonstrative word in the text corresponding to the referent by the object recognition result. However, when a conversation about two or more similar objects is conducted, all of the objects will be corrected to the same name.

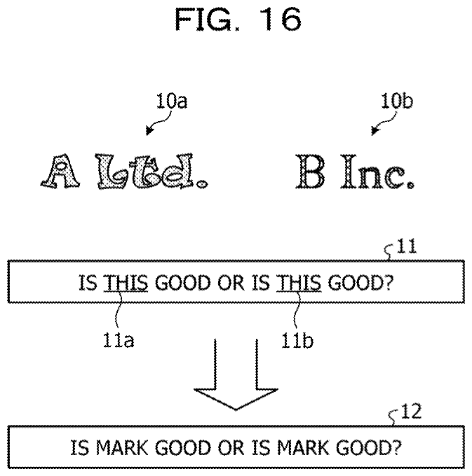

FIG. 16 is a diagram for explaining voice recognition. In FIG. 16, an object (referent) 10a and an object (referent) 10b are mutually different objects, but have similar features. When a user looks at the referents 10a and 10b and states “is this good or is this good?”, text 11 is generated by voice recognition. For example, it is assumed that a demonstrative word “this” 11a in the text 11 is a demonstrative word indicating the referent 10a, and a demonstrative word “this” 11b is a demonstrative word indicating the referent 10b.

For example, when object recognition is performed on image information on the referents 10a and 10b, and the object recognition results for the referents 10a and 10b are both “mark”, the text 11 is complemented to text 12. In the text 12, the two demonstrative words “this” in the text 11 are complemented with the same name “mark”, and it is difficult to distinguish the complemented demonstrative words from each other, which does not make sense as complemented.

In one aspect, a complementary program, a complementary method, and a complementary device capable of creating an appropriate complementary word from demonstrative words regarding two or more similar referents may be provided.

Hereinafter, embodiments will be described of a complementary program, a complementary method, and a complementary device disclosed in the present application in detail with reference to the drawings. Note that the present embodiments are not limited by these examples.

### First Embodiment

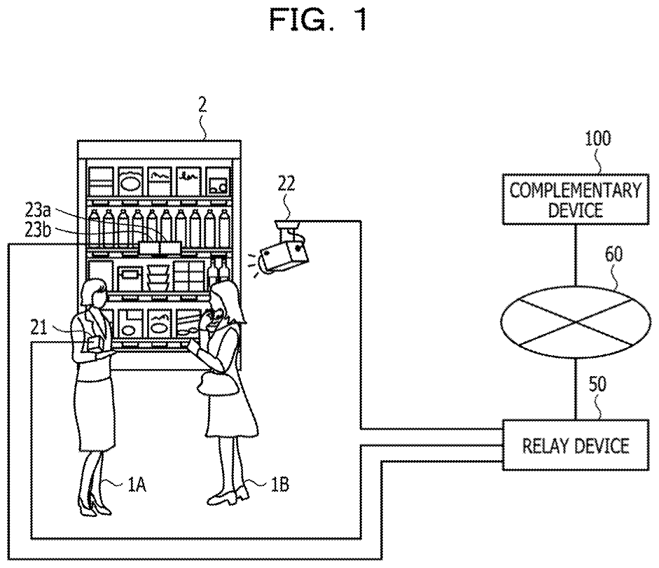

FIG. 1 is a diagram illustrating a system according to a first embodiment. As illustrated in FIG. 1, this system includes a microphone terminal 21, a camera 22, line-of-sight sensors 23a and 23b, a relay device 50, and a complementary device 100. The relay device 50 is connected to the microphone terminal 21, the camera 22, and the line-of-sight sensors 23a and 23b by wire or wirelessly. Furthermore, the relay device 50 is connected to the complementary device 100 via a network 60.

In the system of the first embodiment, a situation is presumed in which a speaker 1A and a speaker 1B have a conversation in front of a product shelf 2. For example, the speaker 1A will be described as a shop clerk and the speaker 1B will be described as a customer, but the present embodiment is not limited to this. The speakers 1A and 1B are examples of a target person.

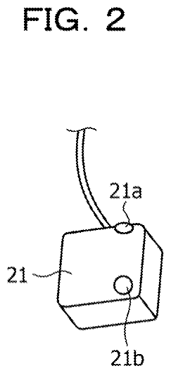

The microphone terminal 21 incorporates at least two microphones. FIG. 2 is a diagram illustrating an exemplary microphone terminal. As illustrated in FIG. 2, the microphone terminal 21 includes microphones 21a and 21b. The speaker 1A wears the microphone terminal 21 on his/her chest. The microphone 21a has an upward sound hole, and mainly picks up the voice of the speaker 1A. The microphone 21b has a forward sound hole, and mainly picks up the voice of the speaker 1B.

The microphone terminal 21 outputs information on the voice of the speaker 1A and information on the voice of the speaker 1B to the relay device 50. In the following description, the information on the voice of the speaker 1A and the information on the voice of the speaker 1B are collectively referred to as “voice information”. Information that identifies the microphone 21a is appended to the voice information picked up by the microphone 21a. Information that identifies the microphone 21b is appended to the voice information picked up by the microphone 21b.

The camera 22 is a camera that captures a video in a capturing range. It is assumed that the capturing range of the camera 22 includes an upper background an d areas near the hands of the speakers 1A and 1B, and the product shelf 2. The camera 22 outputs information on the captured video to the relay device 50. In the following description, information on a video captured by the camera 22 is referred to as “video information”. The video information includes a plurality of pieces of image information (information on still images) in time series.

The line-of-sight sensors 23a and 23b are sensors that detect information expected when the position of the line of sight of the speaker 1A and the position of the line of sight of the speaker 1B are detected. The line-of-sight sensors 23a and 23b are installed on the product shelf 2. In the following description, the line-of-sight sensors 23a and 23b are collectively referred to as “line-of-sight sensors 23”.

For example, the line-of-sight sensors 23 detect the positions of reference points and moving points of the eyes of the speakers 1A and 1B. The reference point is a point indicating a portion of the eye that does not move. The moving point is a point indicating a portion of the eye that moves. The line-of-sight sensor 23 outputs information detected at each time point to the relay device 50.

The relay device 50 converts the voice information and the video information received from the microphone terminal 21 and the camera 22 to files, and transmits the voice information and video information converted to files to the complementary device 100. Furthermore, the relay device 50 detects the positions of the lines of sight of the speakers 1A and 1B on the basis of information detected by the line-of-sight sensor 23, and transmits information on the detected positions of the lines of sight to the complementary device 100.

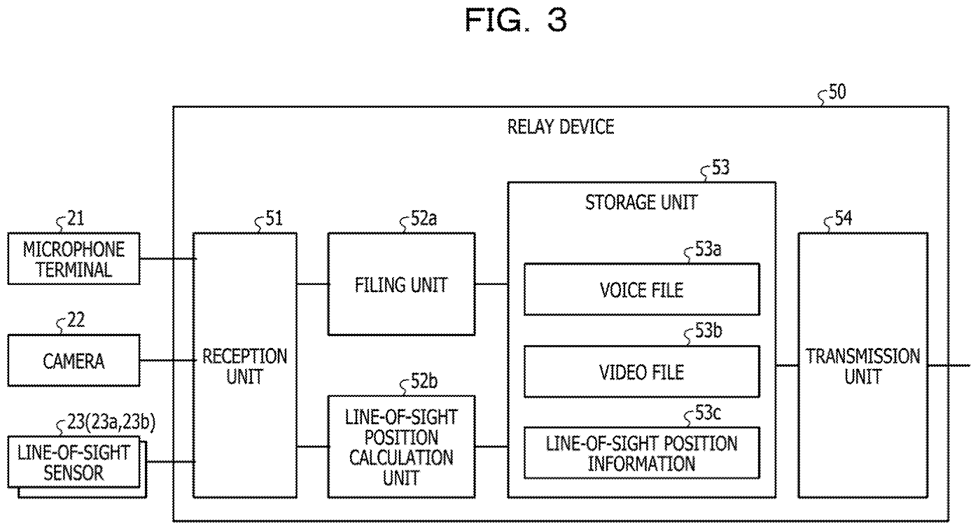

FIG. 3 is a functional block diagram illustrating a configuration of the relay device. As illustrated in FIG. 3, this relay device 50 includes a reception unit 51, a filing unit 52a, a line-of-sight position calculation unit 52b, a storage unit 53, and a transmission unit 54.

The reception unit 51 receives the voice information from the microphone terminal 21, and outputs the received voice information to the filing unit 52a. The reception unit 51 receives the video information from the camera 22, and outputs the received video information to the filing unit 52a. The reception unit 51 receives the information detected by the line-of-sight sensors 23, and outputs the received information to the line-of-sight position calculation unit 52b.

The filing unit 52a generates a voice file 53a by converting the voice information into a file, and stores the generated voice file 53a in the storage unit 53. The filing unit 52a repeatedly executes the above processing every time the voice information is acquired.

The filing unit 52a generates a video file 53b by converting the video information into a file, and stores the generated video file 53b in the storage unit 53. The filing unit 52a repeatedly executes the above processing every time the video information is acquired.

The line-of-sight position calculation unit 52b is a processing unit that calculates the positions of the lines of sight of the speakers 1A and 1B on the basis of the information detected by the line-of-sight sensors 23. The line-of-sight position calculation unit 52b calculates the position of the line of sight of the speaker 1A based on the position of the moving point with respect to the reference point of the speaker 1A. The line-of-sight position calculation unit 52b calculates the position of the line of sight of the speaker 1B based on the position of the moving point with respect to the reference point of the speaker 1B.

Information on the position of the line of sight of the speaker 1A and information on the position of the line of sight of the speaker 1B are collectively referred to as “line-of-sight position information”. The line-of-sight position calculation unit 52b stores line-of-sight position information 53c in the storage unit 53. The line-of-sight position calculation unit 52b calculates the positions of the lines of sight of the speakers 1A and 1B at each time point, and registers the calculated positions in the line-of-sight position information 53c.

The storage unit 53 is a storage device containing the voice file 53a, the video file 53b, and the line-of-sight position information 53c. The storage unit 53 is equivalent to a semiconductor memory element such as a random access memory (RAM), or a flash memory, or a storage device such as a hard disk drive (HDD).

The transmission unit 54 is a processing unit that transmits the voice file 53a, the video file 53b, and the line-of-sight position information 53c stored in the storage unit 53 to the complementary device 100 via the network 60.

The reception unit 51 and the transmission unit 54 of the relay device 50 are equivalent to a communication device. The filing unit 52a and the line-of-sight position calculation unit 52b are equivalent to a predetermined control device or the like

The predetermined control device is implemented by a central processing unit (CPU) or a micro processing unit (MPU), or hard-wired logic such as an application specific integrated circuit (ASIC) or a field programmable gate array (FPGA), or the like.

The description returns to the description of FIG. 1. The complementary device 100 is a device that generates character information on the basis of voice information contained in the voice file 53a, and replaces a demonstrative word contained in the generated character information with a complementary word.

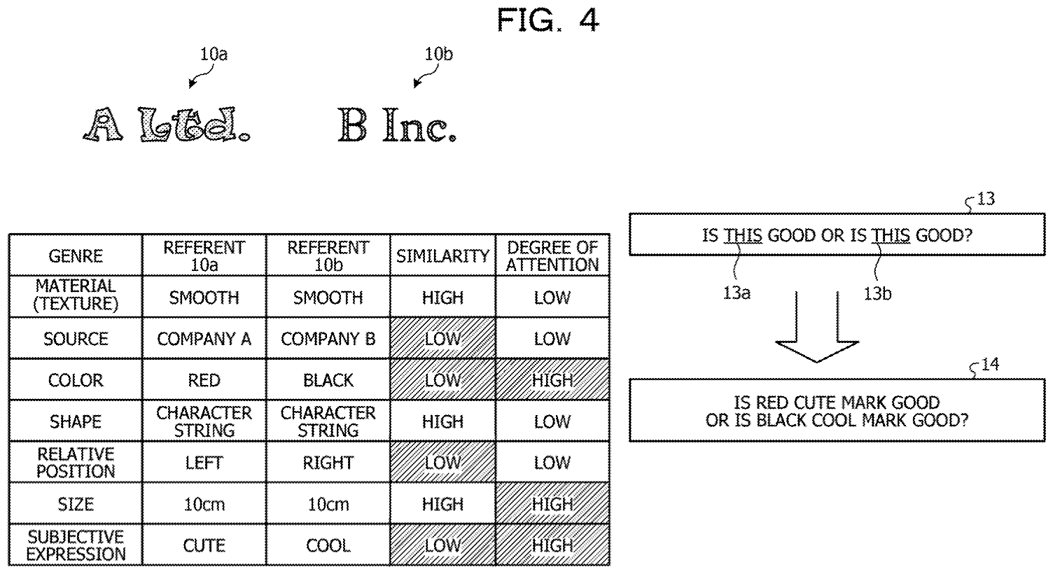

FIG. 4 is a diagram for explaining processing of the complementary device according to the first embodiment. The complementary device 100 extracts character information on the basis of the voice information, and extracts a plurality of demonstrative words from the character information. The complementary device 100 acquires image information corresponding to a time point at which the demonstrative word was uttered, from the video file 53b, and specifies a referent corresponding to each demonstrative word on the basis of the line-of-sight position information.

For example, the complementary device 100 generates character information 13 on the basis of voice information in which the speaker 1A stated “is this good or is this good?” The complementary device 100 extracts a demonstrative word “this” 13a and a demonstrative word “this” 13b from the character information 13.

The complementary device 100 specifies a referent corresponding to the demonstrative word on the basis of the line-of-sight position information and the video information (image information) at a time point when the speaker uttered the demonstrative word. For example, on the basis of the image information at the time of the utterance, the complementary device 100 specifies an object (referent) that was being viewed at a point in time when the speaker uttered the demonstrative word, on the basis of the line-of-sight position information. For example, a referent corresponding to the demonstrative word “this” 13a is assumed as a referent 10a. A referent corresponding to the demonstrative word “this” 13b by the speaker is assumed as a referent 10b.

The complementary device 100 extracts respective features for each genre by examining the image information on the referents 10a and 10b. Examples of the genre include material (texture), source, color, shape, relative position, size, and subjective expression. The material of the referent 10a is assumed as “smooth”, and the material of the referent 10b is assumed as “smooth”. The source of the referent 10a is assumed as “Company A” and the source of the referent 10b is assumed as “Company B”.

The color of the referent 10a is assumed as “red”, and the color of the referent 10b is assumed as “black”. The shape of the referent 10a is assumed as “character string”, and the shape of the referent 10b is assumed as “character string”. The relative position of the referent 10a is assumed as “left”, and the relative position of the referent 10b is assumed as “right”. The size of the referent 10a is assumed as “10 cm”, and the size of the referent 10b is assumed as “10 cm”. The subjective expression of the referent 10a is assumed as “cute”, and the subjective expression of the referent 10b is assumed as “cool”.

The complementary device 100 compares the feature of the referent 10a and the feature of the referent 10b for each genre, and calculates the similarity. For example, regarding the genres “material, shape, size”, it is assumed that the similarity between the features of the referent 10a and the features of the referent 10b is “high” Regarding the genres “source, color, relative position, subjective expression”, it is assumed that the similarity between the features of the referent 10a and the features of the referent 10b is “low”.

The complementary device 100 calculates the number of appearances of related words relating to each genre preset in a word dictionary, from the entire voice information, and calculates the degree of attention of each genre. For example, when the number of appearances is equal to or greater than a threshold, the complementary device 100 determines that the degree of attention is high.

The complementary device 100 modifies general recognition results for the referents 10a and 10b using features of a genre having a lower similarity and a higher degree of attention, and outputs complementary words in place of the demonstrative words. For example, the general recognition results for the referents 10a and 10b are assumed as “mark”. The genre having a lower similarity and a higher degree of attention is assumed as “color” and “subjective expression”.

The complementary device 100 creates a complementary word “red cute mark” obtained by modifying the general recognition result “mark” for the referent 10a with “red” of the genre “color” and “cute” of the genre “subjective expression”. The complementary device 100 replaces the demonstrative word “this” 13a with the complementary word “red cute mark”.

The complementary device 100 creates a complementary word “black cool mark” obtained by modifying the general recognition result “mark” for the referent 10a with “black” of the genre “color” and “cool” of the genre “subjective expression”. The complementary device 100 replaces the demonstrative word “this” 13b with the complementary word “black cool mark”.

The complementary device 100 replaces the demonstrative words in the character information 13 with the complementary words, and generates character information 14 by executing the above processing. The complementary device 100 stores the character information 14 in a storage unit (not illustrated).

As described above, the complementary device 100 according to the first embodiment extracts features for each genre for the referents 10a and 10b corresponding to the demonstrative words 13a and 13b, and calculates the similarity between comparable features and the degree of attention of the genre. The complementary device 100 executes processing of creating complementary words obtained by modifying the general object recognition results for the referents 10a and 10b (the object names of the referents) using features of a genre having a lower similarity and a higher degree of attention, and replacing the demonstrative words 13a and 13b with the created complementary words. Here, it can be said that features having a lower similarity allow a third party to easily grasp what each object is. Furthermore, it can be said that features of a genre having a higher degree of attention convey features of the object in line with the topic. Therefore, an appropriate complementary word may be created by using a feature of a genre having a lower similarity and a higher degree of attention. In addition, by replacing the demonstrative ward with such a complementary word, character information that is easy for a third party to comprehend and to read may be created.

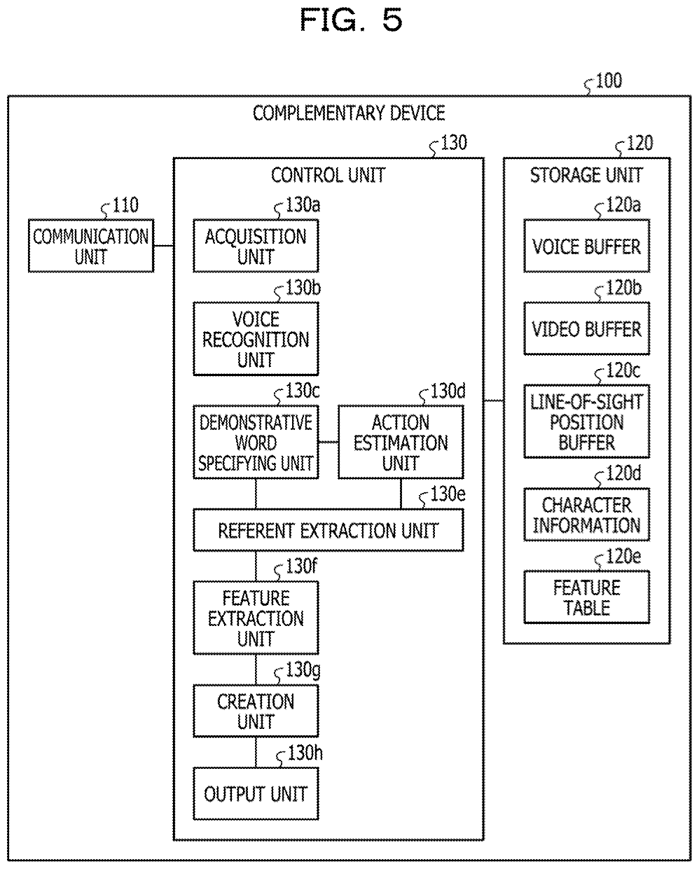

Next, an exemplary configuration of the complementary device 100 according to the first embodiment will be described. FIG. 5 is a functional block diagram illustrating a configuration of the complementary device according to the first embodiment. As illustrated in FIG. 5, this complementary device 100 includes a communication unit 110, a storage unit 120, and a control unit 130.

The communication unit 110 is a processing unit that executes data communication with the relay device 50 via the network 60. The communication unit 110 is equivalent to a communication device. The communication unit 110 receives the voice file 53a, the video file 53b, and the line-of-sight position information 53c from the relay device 50. The communication unit 110 outputs the voice file 53a, the video file 53b, and the line-of-sight position information 53c to the control unit 130.

The storage unit 120 includes a voice buffer 120a, a video buffer 120b, a line-of-sight position buffer 120c, character information 120d, and a feature table 120e. The storage unit 120 is equivalent to a semiconductor memory element such as a RAM or a flash memory, or a storage device such as an HDD.

The voice buffer 120a is a buffer that stores voice information contained in the voice file 53a transmitted from the relay device 50. The voice information stored in the voice buffer 120a includes information indicating the relationship between time and sound intensity. Furthermore, it is assumed that the voice information is appended with information indicating whether the voice information was picked up by the microphone 21a or the microphone 21b. The voice information picked up by the microphone 21a is voice information corresponding to the speaker 1A. The voice information picked up by the microphone 21b is voice information corresponding to the speaker 1B.

The video buffer 120b is a buffer that stores video information contained in the video file 53b transmitted from the relay device 50. The video information stored in the video buffer 120b includes a plurality of pieces of time-series image information. Each piece of image information is associated with time.

The line-of-sight position buffer 120c is a buffer that stores the line-of-sight position information 53c transmitted from the relay device 50. Each position of the line of sight in the line-of-sight position information 53c stored in the line-of-sight position buffer 120c is associated with time.

The character information 120d is character information extracted from the voice information stored in the voice buffer 120a. The character information 120d includes the character information 13 described with reference to FIG. 4. The demonstrative word contained in the character information 120d is to be replaced with a complementary word.

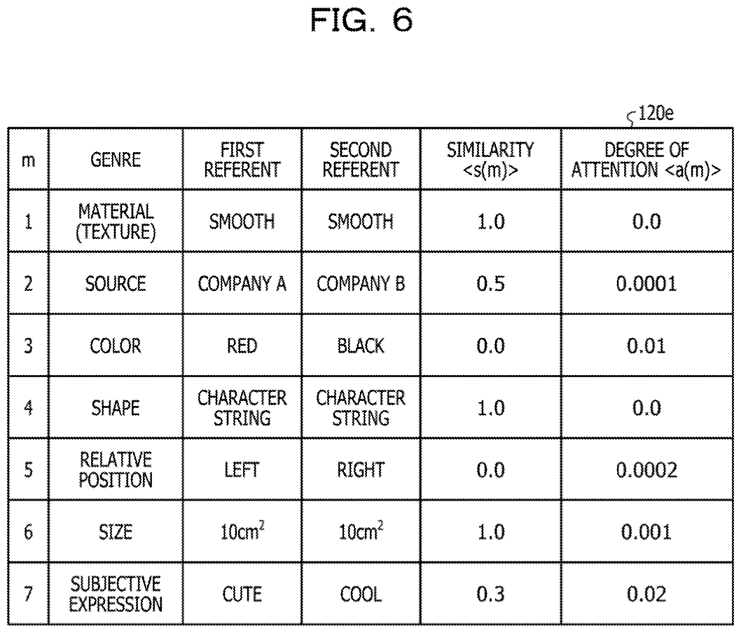

The feature table 120e is a table that holds information on features, the similarity, and the degree of attention of each genre for referents to be compared. FIG. 6 is a diagram illustrating an exemplary data structure of the feature table. As illustrated in FIG. 6, this feature table 120e has a genre, a first referent, a second referent, a similarity, and a degree of attention. Note that the reference sign “m” in FIG. 6 identifies a genre by a set number.

The genre includes the material (texture), source, color, shape, relative position, size, and subjective expression. The numbers m=1 to 7 correspond to the material (texture), source, color, shape, relative position, size, and subjective expression. The first referent and the second referent are to be compared in features. The similarity indicates the similarity between the feature of the first referent and the feature of the second referent. The value of each similarity approaches one as features are more similar. The degree of attention indicates the degree of attention of each genre. The value of the degree of attention increases as a word relating to the feature of the relative genre is more often uttered.

The description returns to the description of FIG. 5. The control unit 130 includes an acquisition unit 130a, a voice recognition unit 130b, a demonstrative word specifying unit 130c, an action estimation unit 130d, a referent extraction unit 130e, a feature extraction unit 130f, a creation unit 130g, and an output unit 130h. The control unit 130 can be implemented by a CPU, an MPU, or the like. Furthermore, the control unit 130 can also be implemented by hard-wired logic such as an ASIC or an FPGA.

The acquisition unit 130a is a processing unit that acquires the voice file 53a, the video file 53b, and the line-of-sight position information 53c from the relay device 50 via the communication unit 110. The acquisition unit 130a stores voice information contained in the voice file 53a in the voice buffer 120a. The acquisition unit 130a stores video information contained in the video file 53b in the video buffer 120b. The acquisition unit 130a stores the line-of-sight position information 53c in the line-of-sight position buffer 120c.

The voice recognition unit 130b is a processing unit that acquires voice information from the voice buffer 120a and extracts the character information 120d on the basis of the voice information. The voice recognition unit 130b may use any voice recognition engine when extracting the character information 120d. For example, the voice recognition unit 130b uses a voice recognition engine such as AmiVoice or Julius. The voice recognition unit 130b stores the character information 120d in the storage unit 120.

When extracting the character information 120d based on the voice information, the voice recognition unit 130b specifies the time point of utterance on the voice information, for each morpheme contained in the character information 120d. The voice recognition unit 130b records each morpheme in the voice information in association with a time point at which the morpheme was uttered.

The demonstrative word specifying unit 130c is a processing unit that specifies a demonstrative word from a character string contained in the character information 120d. For example, the demonstrative word specifying unit 130c specifies a demonstrative word by comparing demonstrative word dictionary information (not illustrated) that defines various demonstrative words, with a character string in the character information 120d. Furthermore, when the demonstrative word is specified, the demonstrative word specifying unit 130c specifies the time point associated with a word (morpheme) corresponding to the demonstrative word.

In the following description, a demonstrative word specified from the character information 120d is referred to as “d(n)”, and a time point at which the demonstrative word occurred is referred to as “dt(n)”. The reference sign “n” is assumed as a referent number for distinguishing each referent. The demonstrative word specifying unit 130c outputs information on the demonstrative word d(n) and the time point dt(n) at which the demonstrative word was detected, to the action estimation unit 130d and the referent extraction unit 130e. The demonstrative word specifying unit 130c appends, to the demonstrative word d(n), information indicating whether the demonstrative word d(n) is a demonstrative word contained in character information extracted from the voice information on the speaker 1A or a demonstrative word contained in character information extracted from the voice information on the speaker 1B.

Furthermore, when the demonstrative word “d(n)” is specified from the character information 120d, the demonstrative word specifying unit 130c appends the position (offset) of the demonstrative word “d(n)” on the character information 120d to the demonstrative word “d(n)”.

The action estimation unit 130d is a processing unit that calculates an average position of the line of sight of the speaker in a time period in accordance with a time point at which the demonstrative word was detected, as a reference. For example, the action estimation unit 130d acquires, from the line-of-sight position buffer 120c, the positions of the lines of sight of the speakers 1A and 1B included in a time “t” that satisfies the condition of “dt(n)−T≤t≤dt(n)+T”. The reference sign T denotes a preset value and is assumed as, for example, “0.5 (seconds)”.

Time-series information on the position of the line of sight of the speaker 1A during the time t is referred to as “e1(t)”. Time-series information on the position of the line of sight of the speaker 1B during the time t is referred to as “e2(t)”. The time-series information e1(t) is defined by Formula (1). The time-series information e2(t) is defined by Formula (2).

e1(t)=(x_e1(t), y_e1(t)) (1)

e2(t)=(x_e2(t), y_e2(t)) (2)

The action estimation unit 130d calculates an average line-of-sight position Ave_e1(n) of the speaker 1A based on Formula (3). The action estimation unit 130d calculates an average line-of-sight position Ave_e2(n) of the speaker 1B based on Formula (4). For example, it is indicated that the average line-of-sight position of the speaker 1A is Ave_e1(n) before and after a time point at which the demonstrative word d(n) occurred. It is indicated that the average line-of-sight position of the speaker 1B is Ave_e2(n) before and after a time point at which the demonstrative word d(n) occurred.

$$[ Formula 1 ]$$

$$\begin{matrix}Ave\_e1 ( n ) = ( \frac{1}{2 T} {\sum }_{dt ( i ) - T}^{dt ( i ) + T} x\_e1 ( i ) , \frac{1}{2 T} {\sum }_{dt ( i ) - T}^{dt ( i ) + T} y\_e1 ( i ) ) \\ [ Formula 2 ] & ( 3 ) \\ Ave\_e2 ( n ) = ( \frac{1}{2 T} {\sum }_{dt ( i ) - T}^{dt ( i ) + T} x\_e2 ( i ) , \frac{1}{2 T} {\sum }_{dt ( i ) - T}^{dt ( i ) + T} y\_e2 ( i ) ) & ( 4 )\end{matrix}$$

The action estimation unit 130d outputs information on the average line-of-sight position Ave_e1(n) of the speaker 1A and information on the average line-of-sight position Ave_e2(n) of the speaker 1B to the referent extraction unit 130e.

The referent extraction unit 130e is a processing unit that extracts information on a referent corresponding to the demonstrative word d(n) on the basis of the image information (video information) stored in the video buffer 120b. The information on the referent extracted by the referent extraction unit 130e includes an object name dn(n), an object position dp(n), and an image Im(n) corresponding to the demonstrative word d(n).

First, a case where a speaker who uttered the demonstrative word d(n) is the speaker 1A will be described. The referent extraction unit 130e acquires, from the video buffer 120b, image information corresponding to the time point dt(n) at which the demonstrative word d(n) occurred.

The referent extraction unit 130e transforms the average line-of-sight position Ave_e1(n) of the speaker 1A into position coordinates on the image. For example, the referent extraction unit 130e uses a transformation table that associates the position of the line of sight with the position coordinates on the image. The position of the line of sight transformed by the transformation table is referred to as “transformed line-of-sight position”.

The referent extraction unit 130e compares the transformed position coordinates with the image information corresponding to the time point dt(n), and detects an object from a predetermined range of image region in accordance with the transformed position coordinates as a reference. For example, the referent extraction unit 130e extracts an edge from the predetermined range of image region, and specifies the outer shape of the object. The referent extraction unit 130e may exclude an object whose area surrounded by the outer shape is smaller than a threshold, as noise. The referent extraction unit 130e extracts the center coordinates of the outer shape of the object, as the object position dp(n). The referent extraction unit 130e cuts out the image of the outer shape of the object and employs the cutout image as the image Im(n). For example, it is assumed that the size of the image information is “1920×1080” and the size of the image Im(n) is “256×256”.

The referent extraction unit 130e inputs the image Im(n) to a general object recognition model, and extracts the object name of the object contained in the image Im(n). For example, the general object recognition model is implemented by neural network (NN). It is assumed that this general object recognition model has been machine-learned in advance using learning data in which an image is associated with an object name.

When the referent extraction unit 130e inputs the image Im(n) to the general object recognition model, the probability for each object name is output from the general object recognition model. The referent extraction unit 130e extracts an object name whose probability is equal to or greater than a threshold, as dn(n). For example, the threshold is assumed as “60%”. The referent extraction unit 130e inputs the image Im(n) to the general object recognition model, and when the relationship between the object name and the probabilities are obtained as “mark: 80%, personal computer: 0.01%, stationery: 0.01%, . . . ”, extracts the mark as dn(n).

Note that the referent extraction unit 130e inputs the image Im(n) to the general object recognition model, and if there is no object name whose probability is equal to or greater than the threshold, categorizes dn(n) as “thing”.

The referent extraction unit 130e outputs information on the object name dn(n), the object position dp(n), and the image Im(n) for the demonstrative word d(n) to the feature extraction unit 130f.

Incidentally, when a speaker who uttered the demonstrative word d(n) is the speaker 1B, the referent extraction unit 130e uses the average line-of-sight position Ave_e2(n) of the speaker 1B to extract the object name dn(n), the object position dp(n), and the image Im(n) for the demonstrative word d(n), in a similar manner to the case of the speaker 1A.

The referent extraction unit 130e repeatedly executes the above-described processing every time the demonstrative word d(n) is acquired from the demonstrative word specifying unit 130c, and the average line-of-sight position of the speaker 1A or 1B is acquired from the action estimation unit 130d.

The feature extraction unit 130f is a processing unit that extracts features of the referents for each genre, the similarity between the respective referents to be compared, and the degree of attention for each genre, on the basis of information acquired from the referent extraction unit 130e. The feature extraction unit 130f registers the results of the extraction in the feature table 120e. As indicated below, the feature extraction unit 130f executes processing of assigning an ID, processing of extracting a feature, processing of calculating the similarity, and processing of calculating the degree of attention.

“Processing of assigning an ID” executed by the feature extraction unit 130f will be described. The feature extraction unit 130f executes the following processing to assign IDs that each identify an object, to a plurality of object names dn(n). The feature extraction unit 130f compares respective ones of a plurality of object positions dp(n) output from the referent extraction unit 130e, and executes clustering to classify comparable object positions dp(n) whose distance from each other is shorter than a predetermined distance, into the same group. The feature extraction unit 130f assigns the same ID to the object names dn(n) with a plurality of object positions dp(n) belonging to the same group. As a result of the clustering, when a plurality of groups is produced, a plurality of referents is present, and when only a single group is produced, one referent alone is involved.

For example, as a result of the clustering, it is assumed that the first group includes dp(1), dp(2), dp(4), and dp(5), and the second group includes dp(3). In this case, the feature extraction unit 130f assigns an ID “001” to the object names dn(1), dn(2), dn(4), and dn(5). The feature extraction unit 130f assigns an ID “002” to the object name dn(3). Any ID may be assigned to each group as long as the assigned ID is a unique ID.

The feature extraction unit 130f counts the number of appearances c_ID(n) of the object names dn(n) to which the same ID is assigned. For example, “the number of appearances c_001(5)=4” means that, at a point in time when the n-th=fifth demonstrative word d(n) is specified, the demonstrative words corresponding to the same referent assigned with the ID “001” has appeared five times. By referring to this number of appearances c_ID(n), whether or not the demonstrative word corresponding to the same referent appears for the first time may be allowed to be determined. The feature extraction unit 130f outputs information on the number of appearances c_ID(n) to the creation unit 130g.

Subsequently, “processing of extracting a feature” executed by the feature extraction unit 130f will be described. The feature extraction unit 130f calculates a feature f(n, m) for each genre on the basis of the image Im(n) corresponding to the demonstrative word d(n). The reference sign “m” denotes a number that identifies the genre, as described with reference to FIG. 6.

For example, the feature f(n, 1) indicates the feature of the genre “material (texture)”. The feature f(n, 2) indicates the feature of the genre “source”. The feature f(n, 3) indicates the feature of the genre “color”. The feature f(n, 4) indicates the feature of the genre “shape”. The feature f(n, 5) indicates the feature of the genre “relative position”. The feature f(n, 6) indicates the feature of the genre “size”. The feature f(n, 7) indicates the feature of the genre “subjective expression”.

When calculating the feature f(n, 1), the feature extraction unit 130f uses a “material identification model”. The material identification model is implemented by the NN. It is assumed that this material identification model has been machine-learned in advance using learning data in which an image is associated with a material. When the feature extraction unit 130f inputs the image Im(n) to the material identification model, the probability for each material is output from the material identification model. The feature extraction unit 130f employs a material (texture) having the highest probability as the feature f(n, 1).

When calculating the feature f(n, 2), the feature extraction unit 130f uses a “source identification model”. The source identification model is implemented by the NN. It is assumed that this source identification model has been machine-learned in advance using learning data in which an image is associated with a source. When the feature extraction unit 130f inputs the image Im(n) to the source identification model, the probability for each source is output from the source identification model. The feature extraction unit 130f employs a source having the highest probability as the feature f(n, 2).

When calculating the feature f(n, 3), the feature extraction unit 130f uses a “color identification model”. The color identification model is implemented by the NN. It is assumed that this color identification model has been machine-learned in advance using learning data in which an image is associated with a color. When the feature extraction unit 130f inputs the image Im(n) to the color identification model, the probability for each color is output from the color identification model. The feature extraction unit 130f employs a color having the highest probability as the feature f(n, 3).

When calculating the feature f(n, 4), the feature extraction unit 130f uses a “shape identification model”. The shape identification model is implemented by the NN. It is assumed that this shape identification model has been machine-learned in advance using learning data in which an image is associated with a shape. When the feature extraction unit 130f inputs the image Im(n) to the shape identification model, the probability for each shape is output from the shape identification model. The feature extraction unit 130f employs a shape having the highest probability as the feature f(n, 4).

When calculating the feature f(n, 5), the feature extraction unit 130f uses a relative position specifying table that associates a relative position with a region. The feature extraction unit 130f compares the relative position specifying table with the object position dp(n), and specifies a region to which the object position dp(n) belongs. The feature extraction unit 130f employs a relative position corresponding to the specified region as the feature f(n, 5).

When calculating the feature f(n, 6), the feature extraction unit 130f detects an edge on the image Im(n) and extracts the outer shape of an object. The feature extraction unit 130f calculates the area inside the outer shape of the object, and employs the calculated area as the feature of the feature f(n, 6).

When calculating the feature f(n, 7), the feature extraction unit 130f uses a “subjective identification model”. The subjective identification model is implemented by the NN. It is assumed that this subjective identification model has been machine-learned in advance using learning data in which an image is associated with a subjective expression. When the feature extraction unit 130f inputs the image Im(n) to the subjective identification model, the probability for each subjective expression is output from the subjective identification model. The feature extraction unit 130f employs a subjective expression having the highest probability as the feature f(n, 7).

By executing the above processing, the feature extraction unit 130f calculates the respective features f(n, m) for each genre with regard to a plurality of dn(n). The feature extraction unit 130f specifies a feature f_ID(m) corresponding to one ID on the basis of a plurality of features f(n, m) corresponding to the same ID. When there is a plurality of features f_ID(m) corresponding to the same ID, the feature extraction unit 130f sets the mode value to the feature f_ID(m).

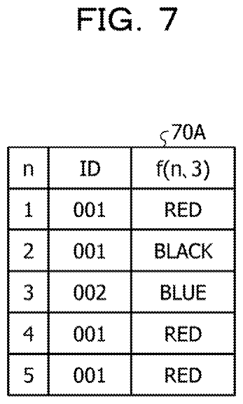

FIG. 7 is a diagram (1) for explaining processing of the feature extraction unit. Table 70A in FIG. 7 indicates the relationship between n, ID, and f(n, 3). The reference sign f(n, 3) indicates the feature of the genre “color”. There are four items of f(n, 3) corresponding to the ID “001”, three of which are “f(n, 3)=red” and one of which is “f(n, 3)=black”. The feature extraction unit 130f sets a feature f_001ID(3) to “red” because the mode value of f(n, 3) with the ID “001” is “f(n, 3)=red”.

In FIG. 7, there is one item of f(n, 3) corresponding to the ID “002”, and this one item is “f(n, 3)=blue”. The feature extraction unit 130f sets a feature f_002ID(3) to “blue” because the mode value of f(n, 3) with the ID “002” is “f(n, 3)=blue”.

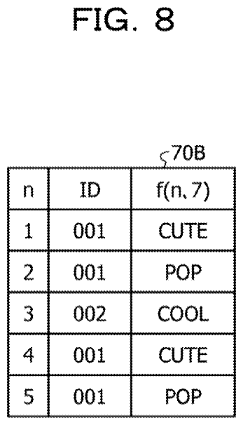

FIG. 8 is a diagram (2) for explaining processing of the feature extraction unit. Table 70B in FIG. 7 indicates the relationship between n, ID, and f(n, 7). The reference sign f(n, 7) indicates the feature of the genre “subjective expression”. There are four items of f(n, 7) corresponding to the ID “001”, two of which are “f(n, 7)=cute” and two of which are “f(n, 7)=pop”. When there is a plurality of features having the same frequency in this manner, the feature extraction unit 130f adopts a feature with a smaller n. For example, the feature extraction unit 130f sets “f(n, 7)=cute” corresponding to n=1 as a feature f_001ID(7). A smaller n is closer to the initial state of the utterance.

In FIG. 8, there is one item of f(n, 7) corresponding to the ID “002”, and the one item is “f(n, 7)=cool”. The feature extraction unit 130f sets a feature f 002ID(7) to “cool” because the mode value of f(n, 7) with the ID “002” is “f(n, 7)=cool”.

The feature extraction unit 130f extracts each feature f_ID(m) corresponding to one ID by repeatedly executing the above processing.

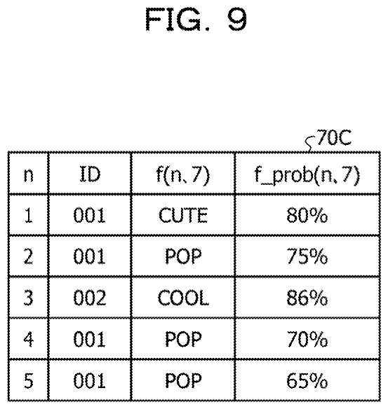

Note that the feature extraction unit 130f may extract each feature f_ID(m) corresponding to one ID by executing another type of processing. FIG. 9 is a diagram for explaining another type of processing of the feature extraction unit. The feature extraction unit 130f inputs the image Im(n) to an identification model, and extracts the features f_ID(m) corresponding to one ID using the probabilities f_prob(n, m) output from this identification model. The feature extraction unit 130f calculates an average value of the probabilities f_prob(n, m) for the same features, and extracts a feature having a greater average value as the feature f_ID(m) corresponding to one ID.

Table 70C in FIG. 9 indicates the relationship between n, ID, f(n, 7), and f_prob(n, 7). Here, f_prob(n, 7) is the probability (maximum probability) of “subjective expression” output from the subjective identification model when the image Im(n) is input to the subjective identification model. There are four items of f(n, 7) corresponding to the ID “001”, one of which is “f(n, 7)=cute” and three of which are “f(n, 7)=pop”.

The feature extraction unit 130f calculates an average value “80%” of f_prob(n, 7) for “f(n, 7)=cute”. The feature extraction unit 130f calculates an average value “70%” of f_prob(n, 7) for “f(n, 7)=pop”. The feature extraction unit 130f sets “f(n, 7)=cute” having a higher average value as a feature f_001(7). Note that, when the average values are the same, the feature extraction unit 130f adopts a feature with a smaller n, as described with reference to FIG. 8.

Subsequently, “processing of calculating the similarity” executed by the feature extraction unit 130f will be described. The feature extraction unit 130f compares respective features for each genre between referents to be compared, which are registered in the feature table 120e, and calculates the similarity.

The processing of calculating the similarity by the feature extraction unit 130f will be described with reference to FIG. 6. Here, as an example, the first referent is assumed as a referent (object name dn(n)) identified by the ID “001”. The second referent is assumed as a referent (object name dn(n)) identified by the ID “002”. The features of each genre are assumed as the features extracted by the above-described “processing of extracting a feature”.

For example, f_001(1)=“smooth”, f_001(2)=“Company A”, f_001(3)=“red”, f_001(4)=“character string”, f_001(5)=“left”, f_001(6)=“10 cm^{2”,} and f_001(7)=“cute” are assumed.

In addition, f_002(1)=“smooth”, f_002(2)=“Company B”, f_002(3)=“black”, f_002(4)=“character string”, f_002(5)=“right”, f_002(6)=“10 cm^{2”,} and f_002(7)=“cool” are assumed.

The feature extraction unit 130f compares f_ID(m) with each other and calculates a similarity s(m) for each genre based on gestalt pattern matching or the like. The feature extraction unit 130f registers information on the calculated similarity s(m) in the feature table 120e.

For example, by the gestalt matching, the similarity s(1) between f_001(1)=“smooth” and f_002(1)=“smooth” is given as “1.0” for the genre “material”. By the gestalt matching, the similarity s(2) between f_001(2)=“Company A” and f_002(2)=“Company B” is given as “0.5” for the genre “source”. By the gestalt matching, the similarity s(3) between f_001(3)=“red” and f_002(3)=“black” is given as “0.0” for the genre “color”.

By the gestalt matching, the similarity s(4) between f_001(4)=“character string” and f_002(4)=“character string” is given as “1.0” for the genre “shape”. By the gestalt matching, the similarity s(5) between f_001(5)=“left” and f_002(5)=“right” is given as “0.0” for the genre “relative position”. By the gestalt matching, the similarity s(6) between f_001(6)=“10 cm^{2”} and f_002(6)=“10 cm^{2”} is given as “1.0” for the genre “size”. By the gestalt matching, the similarity s(7) between f_001(7)=“cute” and f_002(7)=“cool” is given as “0.3” for the genre “subjective impression”.

Subsequently, “processing of calculating the degree of attention” executed by the feature extraction unit 130f will be described. The feature extraction unit 130f specifies a related word relating to a genre based on a preset word dictionary, and calculates the number of appearances of the related words contained in the character information 120d for each genre,

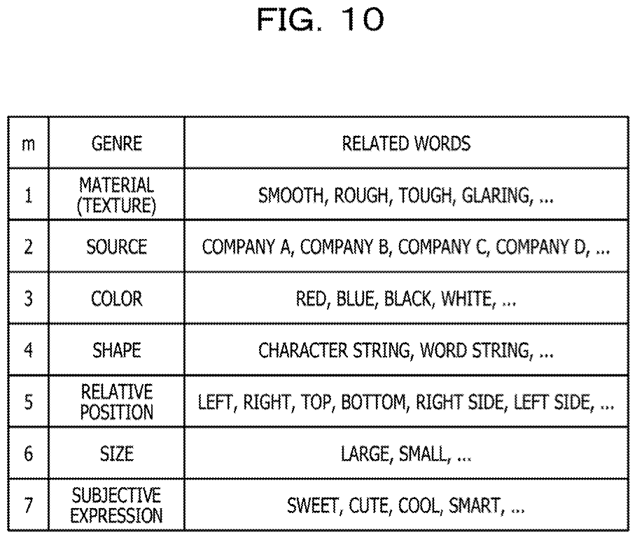

FIG. 10 is a diagram illustrating an exemplary data structure of the word dictionary. As illustrated in FIG. 10, the word dictionary associates m, genre, and related words. Each genre is associated with each of a plurality of related words.

For example, the related words of the genre “material” include “smooth, rough, tough, glaring, . . . ”. The feature extraction unit 130f compares each of the related words “smooth, rough, tough, glaring, . . . ” of the genre “material” with the character information 120d, and calculates the number of appearances obtained by summing the numbers of appearances of the respective related words, as the number of appearances of the related words of the genre “material”. The feature extraction unit 130f calculates the number of appearances of the related words in a similar manner for other genres.

The feature extraction unit 130f calculates the degree of attention a(m) of each genre on the basis of Formula (5). In Formula (5), c(m) indicates the number of appearances of the related words of a genre identified by the number m. The total number of words in a target section indicates the total number of words contained in the character information extracted on the basis of the voice information uttered during a predetermined time period. For example, the predetermined time period indicates a time period from the conversation start time point to the conversation end time point. The conversation start time point is assumed as a time point at which the power first reaches or exceeds a threshold in the voice information stored in the voice buffer 120a. The conversation end time point is assumed as a time point at which the power lastly reaches or exceeds the threshold. Note that an administrator may operate an input device (not illustrated) of the complementary device 100 to designate the predetermined time period.

Degree of Attention a(m)=Number of Appearances of Related Words c(m)/Total Number of Words in Target Section (5)

The feature extraction unit 130f registers information on the degree of attention a(m) of each genre in the feature table 120e.

Incidentally, when one referent is involved alone, the feature extraction unit 130f calculates only the degree of attention a(m) mentioned above, and skips the processing of calculating the similarity.

The description returns to the description of FIG. 5. The creation unit 130g is a processing unit that creates a complementary word corresponding to a demonstrative word contained in the character information 120d on the basis of the feature table 120e. The processing of the creation unit 130g executes different types of processing depending on the value of “number of appearances c_ID(n)” acquired from the feature extraction unit 130f.

The processing of the creation unit 130g when the number of appearances c_ID(n)=0 will be described. The creation unit 130g skips the processing of creating a complementary word r(n) corresponding to the object name dn(n).

The processing of the creation unit 130g when the number of appearances c_ID(n)=1 will be described. The creation unit 130g modifies the object name dn(n) with a feature f_ID(m) that meets the similarity s(m)<TH_S or the degree of attention a(m)>TH_A, and creates the complementary word r(n). Here, the reference sign “TH_S” denotes a threshold for determining the similarity and is preset. The reference sign “TH_A” denotes a threshold for determining the degree of attention, and is preset. For example, TH_S=0.55 and TH_A=0.008 are assumed.

The processing of the creation unit 130g will be described with reference to FIG. 6. For example, a case where the ID “001” (first referent) is assigned to the object name dn(n) will be described. The object name dn(n) is assumed as “mark”. The feature f_ID(m) that meets the similarity s(m)<TH_S or the degree of attention a(m)>TH_A includes features of genres specified by m=2, 3, 5, and 7. The creation unit 130g creates a complementary word r(n) of “Company A's red and cute mark on the left”, using f_001(2)=Company A, f_001(3)=red, f_001(5)=left, and f_001(7)=cute.

A case where the ID “002” (second referent) is assigned to the object name dn(n) will be described. The object name dn(n) is assumed as “mark”. The feature f_ID(m) that meets the similarity s(m)<TH_S or the degree of attention a(m)>TH_A includes features of genres specified by m=2, 3, 5, and 7. The creation unit 130g creates a complementary word r(n) of “Company B's black and cool mark on the right”, using f_002(2)=Company B, f_002(3)=black, f_002(5)=right, and f_002(7)=cool.

The processing of the creation unit 130g in the case of the number of appearances c_ID(n)≥2 will be described. The creation unit 130g modifies the object name dn(n) with a feature f_ID(m) that meets the similarity s(m)<TH_S and the degree of attention a(m)>TH_A, and creates the complementary word r(n).

The processing of the creation unit 130g will be described with reference to FIG. 6. For example, a case where the ID “001” (first referent) is assigned to the object name dn(n) will be described. The object name dn(n) is assumed as “mark”. The feature f_ID(m) that meets the similarity s(m)<TH_S and the degree of attention a(m)>TH_A includes features of genres specified by m=3 and 7. The creation unit 130g creates a complementary word r(n) of “red and cute mark”, using f_001(3)=red and f_001(7)=cute.

A case where the ID “002” (second referent) is assigned to the object name dn(n) will be described. The object name dn(n) is assumed as “mark”. The feature f_ID(m) that meets the similarity s(m)<TH_S and the degree of attention a(m)>TH_A includes features of genres specified by m=3 and 7. The creation unit 130g creates a complementary word r(n) of “black and cool mark” using f_002(3)=black and f_002(7)=cool.

Incidentally, the creation unit 130g may create the complementary word r(n) using only the genre f_ID(m) having the highest degree of attention a(m) when the number of appearances c_ID(n) reaches a threshold number of times chosen in advance (for example, five or more).

For example, a case where the ID “001” (first referent) is assigned to the object name dn(n) will be described. The object name dn(n) is assumed as “mark”. The feature of the genre having the highest degree of attention a(m) is f_001(7)=cute. The creation unit 130g creates a complementary word r(n) of “cute mark”, using f_001(7)=cute.

A case where the ID “002” (second referent) is assigned to the object name dn(n) will be described. The object name dn(n) is assumed as “mark”. The feature of the genre having the highest degree of attention a(m) is f_002(7)=cool. The creation unit 130g creates a complementary word r(n) of “cool mark”, using f_002(7)=cool.

The creation unit 130g creates the complementary word r(n) corresponding to each demonstrative word d(n) one by one by repeatedly executing the above processing. The creation unit 130g outputs, to the output unit 130h, information in which the demonstrative word d(n) is associated with the complementary word r(n).

The output unit 130h executes processing of replacing the demonstrative word d(n) contained in the character information 120d with the complementary word r(n) on the basis of information in which the demonstrative word d(n) is associated with the complementary word r(n). The output unit 130h outputs the character information 120d in which the demonstrative word d(n) is replaced with the complementary word r(n), to an external device (not illustrated) via the network 60.

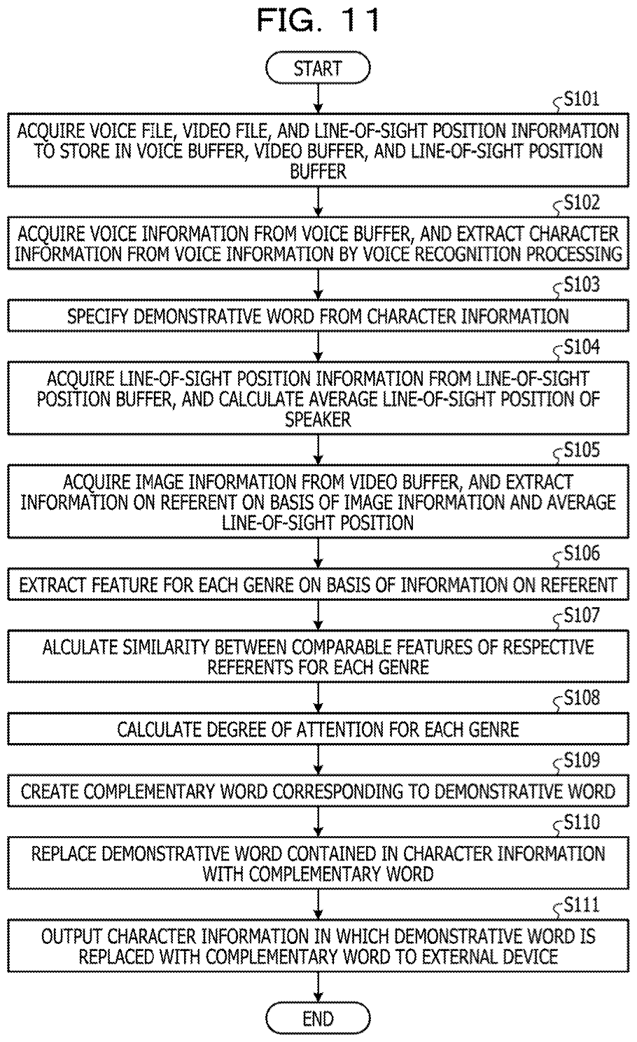

Next, an exemplary processing procedure of the complementary device 100 according to the first embodiment will be described. FIG. 11 is a flowchart illustrating a processing procedure of the complementary device according to the first embodiment. As illustrated in FIG. 11, the acquisition unit 130a of the complementary device 100 acquires the voice file 53a, the video file 53b, and the line-of-sight position information 53c from the relay device 50 to store in the voice buffer 120a, the video buffer 120b, and the line-of-sight position buffer 120c (step S101).

The voice recognition unit 130b of the complementary device 100 acquires voice information from the voice buffer 120a, and extracts the character information 120d from the voice information by voice recognition processing (step S102). The demonstrative word specifying unit 130c of the complementary device 100 specifies a demonstrative word from the character information 120d (step S103). The action estimation unit 130d of the complementary device 100 acquires the line-of-sight position information from the line-of-sight position buffer 120c, and calculates the average line-of-sight position of a speaker (step S104).

The referent extraction unit 130e of the complementary device 100 acquires image information from the video buffer 120b, and extracts information on a referent on the basis of the image information and the average line-of-sight position (step S105). The feature extraction unit 130f of the complementary device 100 extracts a feature for each genre on the basis of the information on the referent (step S106).

The feature extraction unit 130f calculates the similarity between comparable features of respective referents for each genre (step S107). The feature extraction unit 130f calculates the degree of attention for each genre (step S108). The creation unit 130g of the complementary device 100 creates a complementary word corresponding to the demonstrative word (step S109).

The output unit 130h of the complementary device 100 replaces the demonstrative word contained in the character information 120d with the complementary word (step S110). The output unit 130h outputs the character information 120d in which the demonstrative word is replaced with the complementary ward to an external device (step S111).

Next, effects of the complementary device 100 according to the first embodiment will be described. The complementary device 100 extracts the character information 120d from the voice information, and specifies a plurality of demonstrative words from the character information 120d. The complementary device 100 extracts features of referents corresponding to the demonstrative words for each genre on the basis of the image information, and calculates the similarity between the features of the respective referents and the degree of attention for each genre. The complementary device 100 executes processing of creating complementary words obtained by modifying the object names of the referents using features of a genre having a lower similarity and a higher degree of attention, and replacing the demonstrative words with the created complementary words. Here, it can be said that features having a lower similarity allow a third party to easily grasp what each object is. Furthermore, it can be said that features of a genre having a higher degree of attention convey features of the object in line with the topic. Therefore, an appropriate complementary word may be created by using a feature of a genre having a lower similarity and a higher degree of attention. In addition, by replacing the demonstrative word with such a complementary word, character information that is easy for a third party to comprehend and to read may be created.

The complementary device 100 specifies the time point dn(n) at which a voice corresponding to the demonstrative word d(n) was uttered, and acquires image information corresponding to the time point dn(n) from the video buffer 120b. By using the acquired image information and the line-of-sight position information, the complementary device 100 may be allowed to specify a referent on the image information corresponding to the demonstrative word d(n). Furthermore, the complementary device 100 may be allowed to extract information on the referent by specifying the referent. The information on the referent includes the object name dn(n), the object position dp(n), and the image Im(n) corresponding to the demonstrative word d(n).

When comparing features of a plurality of referents for each genre, the complementary device 100 calculates the similarity on the basis of the gestalt matching. Consequently, even when features are compared for each genre on a character basis, the similarity of each feature may be calculated with higher accuracy.

The complementary device 100 calculates the degree of attention for each genre on the basis of the number of appearances of the related words relating to the genre. The related word that appears in the character information 120d extracted from the voice information on a conversation has a close relationship with the degree of attention of the relative genre, such that the degree of attention may be appropriately calculated by using the number of appearances of the related words.

The complementary device 100 performs processing of counting the number of appearances c_ID(n) of the object names dn(n) to which the same ID is assigned, and switching the conditions for a feature used when modifying the object name, according to the counted number of appearances. When the counted number of appearances is “1”, the complementary device 100 creates the complementary word using a feature whose similarity is less than the threshold or whose degree of attention is equal to or greater than the threshold. A case where the counted number of appearances is “1” means that a demonstrative word indicating the relative referent appears for the first time; accordingly, a complementary word obtained by modifying the object name with more features may be created, and the referent may be imagined more specifically.

When the counted number of appearances is “2 or more”, the complementary device 100 creates the complementary word using a feature whose similarity is less than the threshold and whose degree of attention is equal to or greater than the threshold. A case where the counted number of appearances is “2 or more” means that a demonstrative word indicating the relative referent appears for the second or subsequent time; accordingly, by creating a complementary word obtained by modifying the object name with appropriate features, the referent may be imagined more specifically. Furthermore, the length of the complementary word is shorter than in a case where the counted number of appearances is “1”, such that the content of the complementary word may be restricted from becoming redundant.

### Second Embodiment

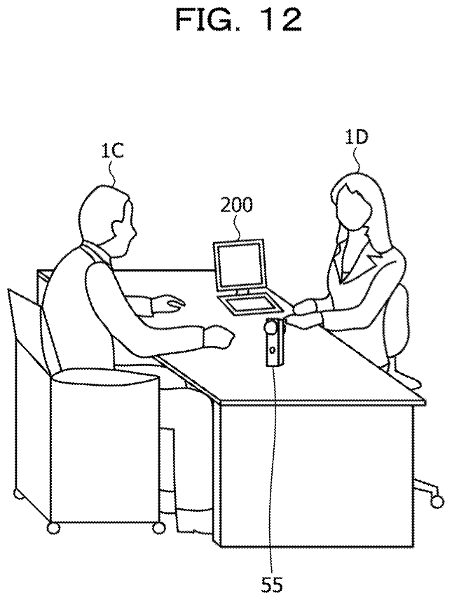

FIG. 12 is a diagram illustrating a system according to a second embodiment. As illustrated in FIG. 12, this system includes a 360-degree camera 55 and a complementary device 200. The camera 55 and the complementary device 200 are connected wirelessly or by wire.

In the system according to the second embodiment, a situation is presumed in which a plurality of people has a conversation in a conference room or the like. In FIG. 12, speakers 1C and 1D are illustrated as an example, but other speakers may be included. Although not illustrated in FIG. 12, it is assumed that products before commercialization, such as logos and other design products, mock-ups, and prototypes, are arranged in front of the speakers 1C and 1D.

The camera 55 is a 360-degree camera that captures a video of surroundings. The camera 55 includes a microphone (not illustrated), and also picks up voice together. The camera 55 generates moving image information including video and voice, and transmits the generated moving image information to the complementary device 200. For example, the camera 55 transmits the moving image information to the complementary device 200 by streaming.

The complementary device 200 acquires the moving image information from the 360-degree camera 55, and separates the moving image information into voice information and video information. The complementary device 200 extracts character information from the voice information, and specifies a plurality of demonstrative words contained in the character information. The complementary device 200 extracts a feature for each genre for each demonstrative word, and calculates the similarity between comparable features and the degree of attention of the genre. The complementary device 200 executes processing of creating complementary words obtained by modifying the general object recognition results for the referents (the object names of the referents) using features of a genre having a lower similarity and a higher degree of attention, and replacing the demonstrative words with the created complementary words.

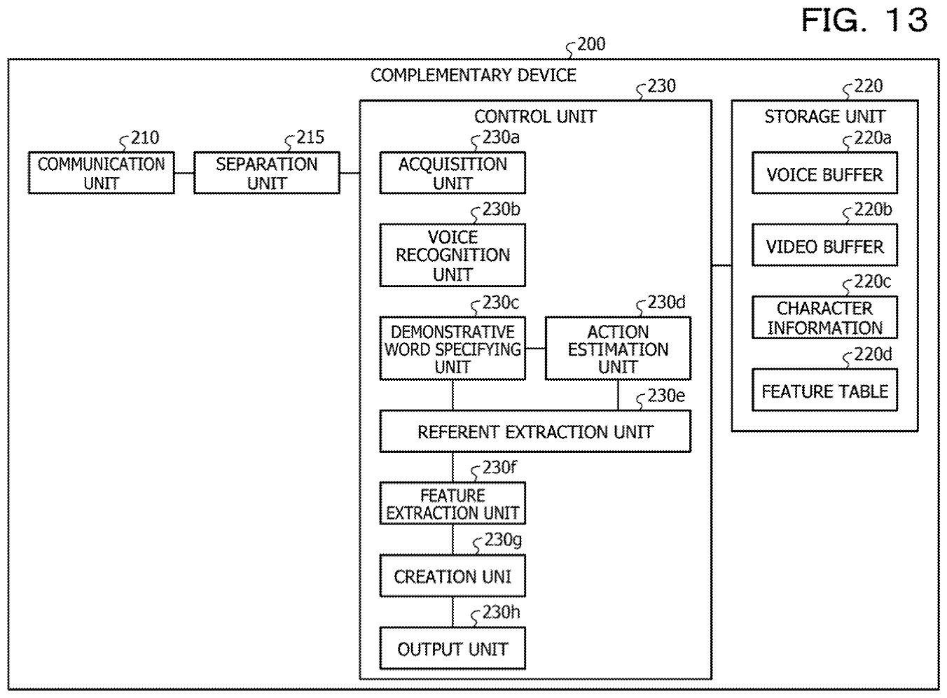

FIG. 13 is a functional block diagram illustrating a configuration of the complementary device according to the second embodiment. As illustrated in FIG. 13, this complementary device 200 includes a communication unit 210, a separation unit 215, a storage unit 220, and a control unit 230.

The communication unit 210 is a communication unit that receives the moving image information from the camera 55. The communication unit 210 may execute data communication with an external device (not illustrated). The communication unit 210 is equivalent to a communication device. The communication unit 210 outputs the moving image information received from the camera 55 to the separation unit 215.

The separation unit 215 is a processing unit that separates the moving image information into voice information and video information, Furthermore, the separation unit 215 separates sound sources into the voice information on the speaker 1C and the voice information on the speaker 1D. The separation unit 215 may use any technique to separate sound sources. The separation unit 215 outputs the video information, the voice information on the speaker 1C, and the voice information on the speaker 1D to the control unit 230.

The second embodiment describes a case where the voice information on each speaker is acquired using a microphone installed in the camera 55, and the voice information is acquired for each speaker by separating sound sources; however, the present embodiment is not limited to this. The speakers 1C and 1D may be each attached with microphones such that the voice information on the speaker 1C and the voice information on the speaker 1D are acquired. The speakers 1C and 1D are examples of a target person.

The storage unit 220 includes a voice buffer 220a, a video buffer 220b, character information 220c, and a feature table 220d. The storage unit 220 is equivalent to a semiconductor memory element such as a RAM or a flash memory, or a storage device such as an HDD.

The voice buffer 220a is a buffer that stores the voice information on the speaker 1C and the voice information on the speaker 1D output from the separation unit 215. In the following description, the voice information on the speaker 1C and the voice information on the speaker 1D are collectively referred to as “voice information”. The voice information includes information indicating the relationship between time and sound intensity.

The video buffer 220b is a buffer that stores the video information output from the separation unit 215. The video information stored in the video buffer 220b includes a plurality of pieces of image information in time series. Each piece of image information is associated with time. In the following description, when one piece of image information is indicated, it is referred to as image information. When a series of continuous pieces of image information is indicated, it is referred to as video information.

The character information 220c is character information extracted from the voice information stored in the voice buffer 220a. For example, the character information 220c includes the character information 13 described in the first embodiment with reference to FIG. 4. The demonstrative word contained in the character information 220c is to be replaced with a complementary word.

The feature table 220d is a table that holds information on the feature, the similarity, and the degree of attention of each genre for the referent to be compared. The data structure of the feature table 220d is similar to the data structure of the feature table 120e described in the first embodiment with reference to FIG. 6. The feature table 220d has a genre, a first referent, a second referent, a similarity, and a degree of attention.

The control unit 230 includes an acquisition unit 230a, a voice recognition unit 230b, a demonstrative word specifying unit 230c, an action estimation unit 230d, a referent extraction unit 230e, a feature extraction unit 230f, a creation unit 230g, and an output unit 230h. The control unit 230 can be implemented by a CPU, an MPU, or the like. Furthermore, the control unit 230 can also be implemented by hard-wired logic such as an ASIC or an FPGA.

The acquisition unit 230a is a processing unit that acquires the voice information and video information from the separation unit 215. The acquisition unit 230a stores the voice information in the voice buffer 220a. The acquisition unit 230a stores the video information in the video buffer 220b.

The voice recognition unit 230b is a processing unit that acquires voice information from the voice buffer 220a and extracts the character information 220c on the basis of the voice information. The voice recognition unit 230b may use any voice recognition engine when extracting the character information 220c. For example, the voice recognition unit 230b uses a voice recognition engine such as AmiVoice or Julius. The voice recognition unit 230b stores the character information 220c in the storage unit 220.

The demonstrative word specifying unit 230c is a processing unit that specifies a demonstrative word from a character string contained in the character information 220c. The demonstrative word specifying unit 230c specifies the demonstrative word d(n) and the time point dt(n) at which the demonstrative word occurred, by executing processing similar to the processing of the demonstrative word specifying unit 130c of the first embodiment. The demonstrative word specifying unit 230c outputs information on the demonstrative word d(n) and the time point dt(n) at which the demonstrative word was detected, to the action estimation unit 230d and the referent extraction unit 230e.

The action estimation unit 230d is a processing unit that determines whether or not the speaker 1C or 1D has performed a pointing action in a time period in accordance with a time point at which the demonstrative word was detected, as a reference, and when the pointing action has been performed, calculates a vector p(n) indicating a pointing direction.

The action estimation unit 230d acquires, from the video buffer 220b, image information corresponding to a time period “t” that satisfies the condition of “dt(n)−T≤t≤dt(n)+T”. The action estimation unit 230d estimates the skeletons of the speakers 1C and 1D in each of the acquired image information. The action estimation unit 230d may estimate the skeletons using any technique; for example, the action estimation unit 230d estimates the skeletons using a technique such as OpenPose.

The action estimation unit 230d calculates a line segment passing through the elbow joint and the wrist joint of the speaker 1C on the basis of the skeleton of the speaker. The action estimation unit 230d determines that the speaker 1C has performed the pointing action, when a time during which the angle between the calculated line segment and a preset horizontal line is kept less than a threshold is equal to or longer than a predetermined time. When determining that the pointing action has been performed, the action estimation unit 230d calculates a direction from the elbow joint to the wrist joint of the speaker 1C as the vector p(n) of the speaker 1C.

The action estimation unit 230d calculates the vector p(n) for the speaker 1D in a similar manner to the case of the speaker 1C. The action estimation unit 230d outputs information on the vector p(n) of the speaker 1C and the vector p(n) of the speaker 1D to the referent extraction unit 230e.

The referent extraction unit 230e is a processing unit that extracts information on a referent corresponding to the demonstrative word d(n) on the basis of the image information (video information) contained in the video buffer 220b. The information on the referent extracted by the referent extraction unit 230e includes an object name dn(n), an object position dp(n), and an image Im(n) corresponding to the demonstrative word d(n).

First, a case where a speaker who uttered the demonstrative word d(n) is the speaker 1C will be described. The referent extraction unit 230e acquires, from the video buffer 220b, image information corresponding to the time point dt(n) at which the demonstrative word d(n) occurred.

The referent extraction unit 230e uses a point on the extension of the vector p(n) of the speaker 1C and a transformation table that allows transformation into coordinates on the image to transform the position of the point on the extension to coordinates on the image. In the following description, the position of a point on the extension of the vector p(n) that has been transformed into coordinates on the image is referred to as a “transformed position”.

The referent extraction unit 230e compares the transformed position with the image information corresponding to the time point dt(n), and detects an object from a predetermined range of image region in accordance with the transformed position as a reference. For example, the referent extraction unit 230e extracts an edge from the predetermined range of image region, and specifies the outer shape of the object. The referent extraction unit 230e may exclude an object whose area surrounded by the outer shape is smaller than a threshold, as noise. The referent extraction unit 230e extracts the center coordinates of the outer shape of the object, as the object position dp(n). The referent extraction unit 230e cuts out the image of the outer shape of the object and employs the cutout image as the image Im(n).

The referent extraction unit 230e inputs the image Im(n) to a general object recognition model, and extracts the object name dn(n) of the object contained in the image Im(n). The referent extraction unit 230e inputs the image Im(n) to the general object recognition model, and if there is no object name whose probability is equal to or greater than a threshold, categorizes dn(n) as “thing”.

The referent extraction unit 230e outputs information on the object name dn(n), the object position dp(n), and the image Im(n) for the demonstrative word d(n) to the feature extraction unit 230f.

Incidentally, when a speaker who uttered the demonstrative word d(n) is the speaker 1D, the referent extraction unit 230e uses the vector p(n) of the speaker 1D to extract the object name dn(n), the object position dp(n), and the image Im(n) for the demonstrative word d(n), in a similar manner to the case of the speaker 1C.

The referent extraction unit 230e repeatedly executes the above-described processing every time the demonstrative word d(n) is acquired from the demonstrative word specifying unit 230c, and the vector p(n) of the speaker 1C or 1D is acquired from the action estimation unit 230d.

The feature extraction unit 230f is a processing unit that extracts features of the referents for each genre, the similarity between the respective referents to be compared, and the degree of attention for each genre, on the basis of information acquired from the referent extraction unit 230e. The feature extraction unit 230f executes processing of assigning an ID, processing of extracting a feature, processing of calculating the similarity, and processing of calculating the degree of attention.

The processing of assigning an ID by the feature extraction unit 230f is similar to the processing of assigning an ID executed by the feature extraction unit 130f of the first embodiment. The processing of extracting a feature by the feature extraction unit 230f is similar to the processing of extracting a feature executed by the feature extraction unit 130f of the first embodiment.

“Processing of calculating the similarity” executed by the feature extraction unit 230f will be described. The feature extraction unit 230f compares respective features for each genre between referents to be compared, which are registered in the feature table 220d, and calculates the similarity.

The processing of calculating the similarity by the feature extraction unit 230f will be described with reference to FIG. 6. Here, as an example, the first referent is assumed as a referent (object name dn(n)) identified by the ID “001”. The second referent is assumed as a referent (object name dn(n)) identified by the ID “002”. The features of each genre are assumed as the features extracted by the above-described “processing of extracting a feature”.

The feature extraction unit 230f calculates a word vector indicating the feature f_ID(m) in a distributed expression using word2vec or the like. For example, the feature extraction unit 230f calculates a cosine similarity between comparable word vectors of f_ID(m) as the similarity s(m).

For example, the feature extraction unit 230f calculates a cosine similarity between the word vector of f_001(1)=“smooth” and the word vector of f_002(1)=“smooth” for the genre “material”, and registers information on the calculated similarity s(m) in the feature table 220d. The feature extraction unit 230f calculates the cosine similarity between comparable word vectors of features in a similar manner for other genres, and registers the calculated cosine similarity in the feature table 220d.

“Processing of calculating the degree of attention” executed by the feature extraction unit 230f will be described. The feature extraction unit 230f specifies a word relating to the genre based on a preset word dictionary. The feature extraction unit 230f compares the related word with the character information 220c to specify the related word contained in the character information 220c, and calculates a time point gw(m, l) at which the related word was uttered. The reference sign “l” denotes a number that identifies the related word.

Here, it is assumed that, when extracting the character information 220c on the basis of the voice information, the voice recognition unit 230b records each word (morpheme) in the voice information in association with a time point at which the word was uttered.

The feature extraction unit 230f acquires the voice information for several seconds before and after gw(m, l) from the voice buffer 220a, and calculates the degree of activity of the voice. The feature extraction unit 230f calculates the degree of activity using a technique disclosed in WO2017/168663 or the like.

For example, the feature extraction unit 230f specifies a fundamental frequency of the voice information, and calculates a relaxation value obtained by changing the fundamental frequency, in time series such that the change of the specified fundamental frequency becomes gentle. The feature extraction unit 230f calculates the degree of activity based on the extent in size of a difference between at least one feature amount relating to the fundamental frequency and the relaxation value corresponding to the feature amount. The greater the difference, the greater the degree of activity. The degree of activity has a value ranging from 0 to 100. When there is a plurality of related words for one genre, a value obtained by averaging the degrees of activity of respective related words is employed as the degree of attention a(m), and is registered in the feature table 220d in association with the relative genre.

The feature extraction unit 230f calculates the degree of attention a(m) of each genre by repeatedly executing the above-described processing for each genre. The feature extraction unit 230f registers the degree of attention a(m) of each genre in the feature table 220d. When there is no gw(m, l), the feature extraction unit 230f sets the degree of attention a(m) to zero.

Incidentally, the feature extraction unit 230f may calculate the degree of attention for each genre by executing another type of processing. For example, the feature extraction unit 230f may calculate the degree of attention a(m) on the basis of emotion estimated from the facial expression of the speaker.

The feature extraction unit 230f calculates the time point gw(m, l) at which the related word was uttered, in a similar manner to the above processing. The feature extraction unit 230f acquires the video information for several seconds before and after the time point gw(m, l) from the video buffer 220b, and analyzes the emotion of the speaker. The feature extraction unit 230f calculates the degree of attention a(m) on the basis of the analysis result for the speaker's emotion. For example, several seconds before and after the time point gw(m, l) correspond to “related section”.

For example, the feature extraction unit 230f outputs the probability of each emotion estimated from the facial expression using an Emotion Application Programming Interface (API) or the like, and multiplies each probability by a coefficient according to the emotion. The feature extraction unit 230f calculates the degree of attention a(m) by summing the respective multiplication results. The feature extraction unit 230f multiplies the probability by a coefficient “+1” for a positive emotion. The feature extraction unit 230f multiplies the probability by a coefficient “0” for an ordinary emotion. The feature extraction unit 230f multiplies the probability by a coefficient “−1” for a negative emotion.

The positive emotion is assumed to include “happiness, surprise”. The ordinary emotion is assumed to include “neutral”. The negative emotion is assumed to include “anger, contempt, disgust, fear, sadness”.

The probabilities of the emotions obtained by the feature extraction unit 230f on the basis of the video information for several seconds before and after gw(m, 1) are assumed as “happiness=0.06, surprise=0.92, neutral 0.005, anger=0.00, contempt=0.0001, disgust=0.003, fear=0.0005, sadness=0.00007”. In this case, the degree of attention a(m) for gw(m, 1) is found by “|1*(0.06+0.92)+0*0.005−1*(0.00+0.0001+0.003+0.0005+0.00007)|”.

Note that the feature extraction unit 230f may calculate the degree of attention a(m) on the basis of the gesture of the speaker. The feature extraction unit 230f calculates the time point gw(m, l) at which the related word was uttered, in a similar manner to the above processing. The feature extraction unit 230f acquires image information corresponding to gw(m, l) from the video buffer 220b, and estimates the posture of the speaker on the basis of a technique such as OpenPose. The feature extraction unit 230f calculates the extent of forward inclination of the upper body of the speaker as a(m).

For example, the feature extraction unit 230f calculates the angle formed between a preset perpendicular and a straight line passing through the backbone of the speaker, and increases the value of the degree of attention a(m) as the formed angle is greater.

The creation unit 230g is a processing unit that creates a complementary word corresponding to a demonstrative word contained in the character information 220c on the basis of the feature table 220d.

The creation unit 230g modifies the object name dn(n) with a feature f_ID(m) that meets the similarity s(m)<TH_S and the degree of attention a(m)>TH_A, and creates the complementary word r(n).

The creation unit 230g sets the average value of the degrees of attention a(m) calculated by the feature extraction unit 230f within a predetermined section, as the threshold “TH_A” for determining the degree of attention. The predetermined section is assumed as a section from the utterance start time point to dt(n). The threshold for determining the similarity is preset, and is assumed as, for example, TH_S=0.5. A section from the utterance start time point to dt(n) is an example of a related section.

The output unit 230h executes processing of replacing the demonstrative word d(n) contained in the character information 220c with the complementary word r(n) on the basis of information in which the demonstrative word d(n) is associated with the complementary word r(n). The output unit 230h may output the character information 220c in which the demonstrative word d(n) is replaced with the complementary word r(n) to an external device.

Furthermore, the output unit 230h may generate information on a summary sentence on the basis of the character information 220c, and store the generated information in the storage unit 220. For example, the output unit 230h uses the technique described in the literature (Nenkova, A., & McKeown, K., “Automatic summarization”, Foundations and Trends in Information Retrieval, 5 (2-3), 103-233, 2011) to create a summary sentence. The output unit 230h may output the information on the summary sentence to an external device.

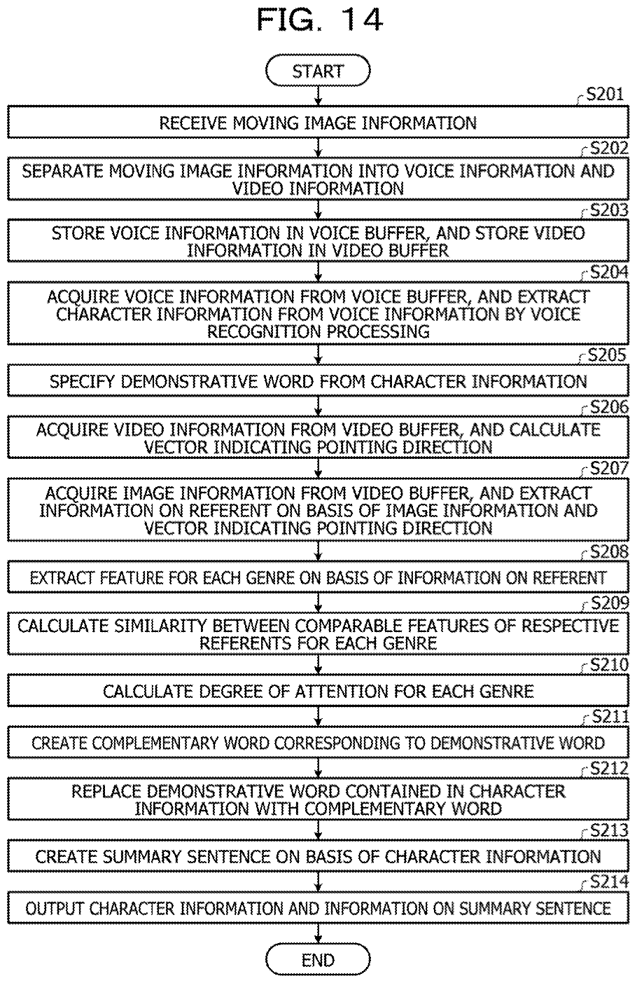

Next, an exemplary processing procedure of the complementary device 200 according to the second embodiment will be described. FIG. 14 is a diagram illustrating an exemplary processing procedure of the complementary device according to the second embodiment. As illustrated in FIG. 14, the communication unit 210 of the complementary device 200 receives the moving image information from the camera 55 (step S201). The separation unit 215 of the complementary device 200 separates the moving image information into voice information and video information (step S202). The separation unit 215 stores the voice information in the voice buffer, and stores the video information in the video buffer (step S203).

The voice recognition unit 230b of the complementary device 200 acquires the voice information from the voice buffer 220a, and extracts the character information 220c from the voice information by voice recognition processing (step S204). The demonstrative word specifying unit 230c of the complementary device 200 specifies a demonstrative word from the character information 220c (step S205).

The action estimation unit 230d of the complementary device 200 acquires the video information from the video buffer 220b, and calculates a vector indicating the pointing direction (step S206). The referent extraction unit 230e of the complementary device 200 acquires image information from the video buffer 220b, and extracts information on a referent on the basis of the image information and the vector indicating the pointing direction (step S207).

The feature extraction unit 230f of the complementary device 200 extracts a feature for each genre on the basis of the information on the referent (step S208). The feature extraction unit 230f calculates the similarity between comparable features of respective referents for each genre (step S209). The feature extraction unit 230f calculates the degree of attention for each genre (step S210). The creation unit 230g of the complementary device 200 creates a complementary word corresponding to the demonstrative word (step S211).

The output unit 230h of the complementary device 200 replaces the demonstrative word contained in the character information 220c with the complementary word (step S212). The output unit 230h creates a summary sentence on the basis of the character information 220c (step S213). The output unit 230h outputs the character information 220c and information on the summary sentence to an external device (step S214).

Next, effects of the complementary device 200 according to the second embodiment will be described. The complementary device 200 specifies the time point dn(n) at which a voice corresponding to the demonstrative word d(n) was uttered, acquires video information corresponding to a period before and after the time point dn(n) from the video buffer 220b, and calculates a vector in the pointing direction. The complementary device 200 may be allowed to specify the referent on the image information corresponding to the demonstrative word d(n) on the basis of the calculated vector in the pointing direction. Furthermore, the complementary device 200 may be allowed to extract information on the referent by specifying the referent. The information on the referent includes the object name dn(n), the object position dp(n), and the image Im(n) corresponding to the demonstrative word d(n).

When comparing features of a plurality of referents for each genre, the complementary device 200 calculates the similarity on the basis of the word vectors corresponding to the features. Consequently, a similarity indicating whether or not the meanings of the respective features are similar may be calculated.

The complementary device 200 acquires, from the video buffer 220b, video information for several seconds before and after the time point gw(m, l) at which the related word was uttered, to analyze the emotion of the speaker, and calculates the degree of attention a(m) on the basis of the analysis result for the emotion of the speaker. Consequently, the degree of attention focusing on the emotion of the speaker may be calculated.

The complementary device 200 acquires, from the video buffer 220b, image information at the time point gw(m, l) at which the related word was uttered, to specify a gesture of the speaker, and calculates the degree of attention a(m) according to the gesture of the speaker. Consequently, the degree of attention focusing on the gesture of the speaker may be calculated.

Incidentally, the complementary device 200 described in the second embodiment receives the moving image information from the camera 55 to extract the character information, specify the demonstrative word, and create the complementary word, but is not limited to this. The complementary device 200 may be connected to the microphone terminal 21 and the camera 22 illustrated in FIG. 1, and acquire the voice information and video information to extract the character information, specify the demonstrative word, and create the complementary word.

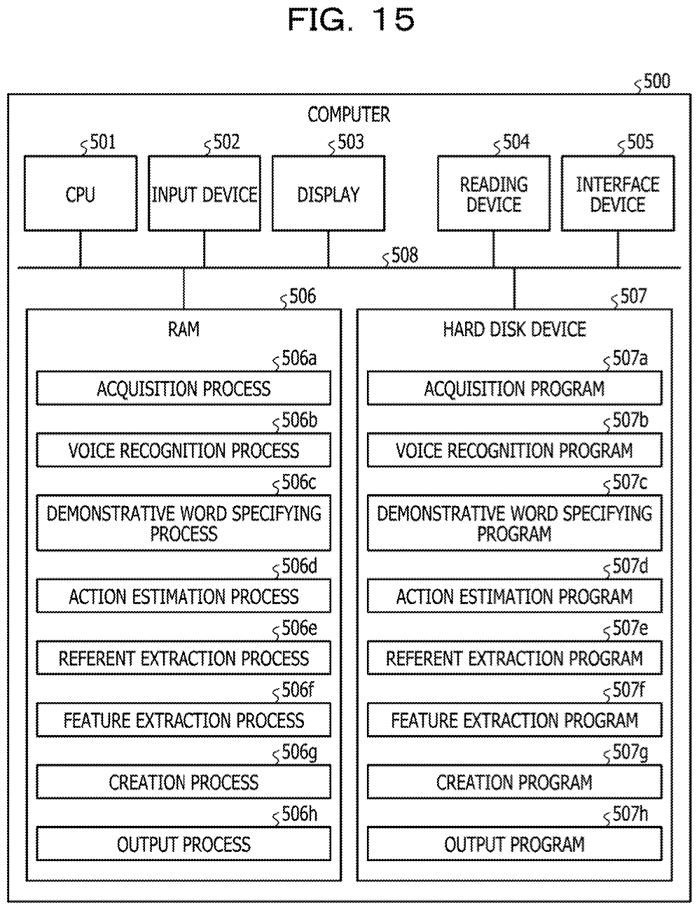

Next, an exemplary hardware configuration of a computer that implements functions similar to those of the complementary device 100 (200) described in the embodiments above will be described. FIG. 15 is a diagram illustrating an exemplary hardware configuration of a computer that implements functions similar to those of the complementary device.

As illustrated in FIG. 15, a computer 500 includes a CPU 501 that executes various types of arithmetic processing, an input device 502 that receives data input from a user, and a display 503. Furthermore, the computer 500 includes a reading device 504 that reads a program or the like from a storage medium. The computer 500 includes an interface device 505 that exchanges data with the relay device 50 and the camera 55. The computer 500 includes a RAM 506 that temporarily stores various types of information, and a hard disk device 507. Then, each of the devices 501 to 507 is connected to a bus 508.

The hard disk device 507 includes an acquisition program 507a, a voice recognition program 507b, a demonstrative word specifying program 507c, an action estimation program 507d, a referent extraction program 507e, and a feature extraction program 507f. The hard disk device 507 includes a creation program 507g and an output program 507h. The CPU 501 reads the acquisition program 507a, the voice recognition program 507b, the demonstrative word specifying program 507c, the action estimation program 507d, the referent extraction program 507e, and the feature extraction program 507f to expand in the RAM 506. The CPU 501 reads the creation program 507g and the output program 507h to expand in the RAM 506.

The acquisition program 507a functions as an acquisition process 506a. The voice recognition program 507b functions as a voice recognition process 506b. The demonstrative word specifying program 507c functions as a demonstrative word specifying process 506c. The action estimation program 507d functions as an action estimation process 506d. The referent extraction program 507e functions as a referent extraction process 506e. The feature extraction program 507f functions as a feature extraction process 506f. The creation program 507g functions as a creation process 506g. The output program 507h functions as an output process 506h.

The processing of the acquisition process 506a corresponds to the processing of the acquisition units 130a and 230a. The processing of the voice recognition process 506b corresponds to the processing of the voice recognition units 130b and 230b. The processing of the demonstrative word specifying process 506c corresponds to the processing of the demonstrative word specifying units 130c and 230c. The processing of the action estimation process 506d corresponds to the processing of the action estimation units 130d and 230d. The processing of the referent extraction process 506e corresponds to the processing of the referent extraction units 130e and 230e. The processing of the feature extraction process 506f corresponds to the processing of the feature extraction units 130f and 230f. The processing of the creation process 506g corresponds to the processing of the creation units 130g and 230g. The processing of the output process 506h corresponds to the processing of the output units 130h and 230h.

Note that the respective programs 507a to 507h may not necessarily be stored in the hard disk device 507 beforehand. For example, each of the programs may be stored in a “portable physical medium” such as a flexible disk (FD), a compact disc (CD)-ROM, a digital versatile disk (DVD), a magneto-optical disk, or an integrated circuit (IC) card to be inserted in the computer 500. Then, the computer 500 may read the respective programs 507a to 507h to execute them.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a complementary program for causing a computer to execute processing comprising:
specifying a plurality of demonstrative words from character information extracted from voice information;
extracting, from among the plurality of demonstrative words, a first feature of a first referent corresponding to a first demonstrative word for each of genres, and a second feature of a second referent corresponding to a second demonstrative word for each of the genres, one by one on a basis of image information;
calculating a similarity between the first feature and the second feature corresponding to a same one of the genres for each of the genres;
calculating a degree of attention for each of the genres on a basis of at least one or more pieces of information out of the voice information, the character information, and the image information;
selecting at least one or more genres on a basis of the similarity and the degree of attention;
creating a first complementary word obtained by modifying a name of the first referent with the first feature corresponding to each of the selected one or more genres; and
creating a second complementary word obtained by modifying a name of the second referent with the second feature corresponding to each of the selected one or more genres.

2. The non-transitory computer-readable recording medium according to claim 1, the complementary program causing the computer to further execute processing comprising: generating action estimation information that estimates an action of a target person to be analyzed, based on the image information; and specifying a referent corresponding to a demonstrative word on a basis of image information captured at an utterance time point at which a voice corresponding to the demonstrative word was uttered in the voice information, and the action estimation information.

3. The non-transitory computer-readable recording medium according to claim 2, wherein the processing of generating the action estimation information generates a position of a line of sight of the target person, as the action estimation information.

4. The non-transitory computer-readable recording medium according to claim 2, wherein the processing of generating the action estimation information generates a direction indicated by a predetermined part of the target person, as the action estimation information.

5. The non-transitory computer-readable recording medium program according to claim 1, wherein the processing of calculating the similarity calculates a degree of coincidence between a character string of the first feature and a character string of the second feature, as the similarity.

6. The non-transitory computer-readable recording medium according to claim 1, wherein the processing of calculating the similarity calculates the similarity on a basis of a vector that indicates meaning of a character string of the first feature and a vector that indicates meaning of a character string of the second feature.

7. The non-transitory computer-readable recording medium according to claim 1, wherein the processing of calculating the degree of attention calculates a number of appearances of a word that relates to any one of the genres, on a basis of the character information, and calculates the degree of attention based on the number of appearances.

8. The non-transitory computer-readable recording medium according to claim 1, wherein the processing of calculating the degree of attention extracts, from the voice information, a voice in a related section in which a word that relates to any one of the genres appears, and calculates the degree of attention on a basis of a feature of the voice in the related section.

9. The non transitory computer-readable recording medium program according to claim 1, wherein the processing of calculating the degree of attention calculates the degree of attention on a basis of a feature regarding a facial expression or a gesture of the target person on a basis of image information corresponding to the related section in which a word that relates to any one of the genres appears.

10. The non-transitory computer-readable recording medium program according to claim 8, the complementary program causing the computer to further execute, in the processing of calculating the degree of attention, specifying, as the related section, a predetermined section before an utterance time point at which a voice corresponding to a demonstrative word was uttered in the voice information.

11. The non-transitory computer-readable recording medium according to claim 1, the complementary program causing the computer to further execute counting, in the image information, a number of appearances for appearance of the first referent in a period from an utterance start time point until the first demonstrative word was uttered in the voice information, wherein
when the number of appearances is one, the processing of creating the first complementary word creates the first complementary word obtained by modifying the name of the first referent with the first feature corresponding to a genre that has the similarity less than a threshold or the degree of attention equal to or greater than a threshold.

12. The non-transitory computer-readable recording medium according to claim 11, wherein, when the number of appearances is two or more, the processing of creating the first complementary word creates the first complementary ward obtained by modifying the name of the first referent with the first feature corresponding to a genre that has the similarity less than the threshold and the degree of attention equal to or greater than the threshold.

13. A complementary method executed by a computer, the complementary method comprising:
specifying a plurality of demonstrative words from character information extracted from voice information;
extracting, from among the plurality of demonstrative words, a first feature of a first referent corresponding to a first demonstrative word for each of genres, and a second feature of a second referent corresponding to a second demonstrative word for each of the genres, one by one on a basis of image information;
calculating a similarity between the first feature and the second feature corresponding to a same one of the genres for each of the genres;
calculating a degree of attention for each of the genres on a basis of at least one or more pieces of information out of the voice information, the character information, and the image information;
selecting at least one or more genres on a basis of the similarity and the degree of attention;
creating a first complementary word obtained by modifying a name of the first referent with the first feature corresponding to each of the selected one or more genres; and
creating a second complementary word obtained by modifying a name of the second referent with the second feature corresponding to each of the selected one or more genres,

14. The complementary method according to claim 13, wherein the computer further executes:
generating action estimation information that estimates an action of a target person to be analyzed, based on the image information; and
specifying a referent corresponding to a demonstrative word on a basis of image information captured at an utterance time point at which a voice corresponding to the demonstrative word was uttered in the voice information, and the action estimation information,

15. The complementary method according to claim 13, wherein the calculating the similarity calculates a degree of coincidence between a character string of the first feature and a character string of the second feature, as the similarity.

16. The complementary method according to claim 13, wherein the calculating the similarity calculates the similarity on a basis of a vector that indicates meaning of a character string of the first feature and a vector that indicates meaning of a character string of the second feature.

17. An information processing device comprising:
a memory; and
a processor coupled to the memory and configured to:
specify a plurality of demonstrative words based on character information extracted from voice information;
extract, from among the plurality of demonstrative words, a first feature of a first referent corresponding to a first demonstrative word for each of genres, and a second feature of a second referent corresponding to a second demonstrative word for each of the genres, one by one on a basis of image information;
calculate a similarity between the first feature and the second feature corresponding to a same one of the genres for each of the genres;
calculate a degree of attention for each of the genres on a basis of at least one or more pieces of information out of the voice information, the character information, and the image information; and
select at least one or more genres on a basis of the similarity and the degree of attention;
create a first complementary word obtained by modifying a name of the first referent with the first feature corresponding to each of the selected one or more genres; and
create a second complementary word obtained by modifying a name of the second referent with the second feature corresponding to each of the selected one or more genres

18. The information processing device according to claim 17, wherein the processor is configured to:
generate action estimation information that estimates an action of a target person to be analyzed, based on the image information; and
specify a referent corresponding to a demonstrative word on a basis of image information captured at an utterance time point at which a voice corresponding to the demonstrative word was uttered in the voice information, and the action estimation information.

19. The information processing device according to claim 17, wherein the processor is configured to calculate a degree of coincidence between a character string of the first feature and a character string of the second feature, as the similarity.

20. The information processing device according to claim 17, wherein the processor is configured to calculate the similarity on a basis of a vector that indicates meaning of a character string of the first feature and a vector that indicates meaning of a character string of the second feature.
